(19) United States
(12) Patent Application Publication
(10) Pub. No.: US 2017/0147993 A1
(43) Pub. Date: May 25, 2017

(54) DOCUMENT PROCESSING METHOD AND APPARATUS AND TERMINAL DEVICE

(71) Applicant: XIAOMI INC., Beijing (CN)

(72) Inventors: Tiejun LIU, Beijing (CN); Pengfei ZHANG, Beijing (CN); Xingsheng LIN, Beijing (CN)

(73) Assignee: XIAOMI INC., Beijing (CN)

(21) Appl. No.: 15/334,859

(22) Filed: Oct. 26, 2016

(30) Foreign Application Priority Data
Nov. 24, 2015 (CN) 201510824157.0

(51) Int. Cl. G06Q 20/04; G06Q 40/02

(52) U.S. Cl. CPC G06Q 20/0453; G06Q 40/025

(57) ABSTRACT

A document processing method, an apparatus, and a terminal device are provided. In the method: the apparatus acquires an electronic document. The apparatus identifies a wearable device identification corresponding to the electronic document. The apparatus sends the electronic document and the corresponding wearable device identification to a server, so that the server stores the electronic document in a user account corresponding to the wearable device identification. Meanwhile, storing the electronic document in association with the user account corresponding to the wearable device identification allows the wearable device to function as an identification device, extends the application of the wearable device, and improves user experience.

### CROSS-REFERENCE TO RELATED APPLICATION

This application is based on and claims priority to Chinese Patent Application No. 201510824157.0, filed on Nov. 24, 2015, which is incorporated herein by reference in its entirety.

### TECHNICAL FIELD

The present disclosure generally relates to the field of communications, and more particularly, to a document processing method and apparatus and a terminal device.

### BACKGROUND

Generally, when a customer makes a payment after shopping in a supermarket or dinning in a restaurant, an attendant often prints and provides a paper document to the customer. However, the paper document tends to be thrown away by the customer carelessly, thereby resulting in a waste of paper resources.

In addition, wearable devices such as smart bracelets and smart watches have been widely used by people, mainly for monitoring their own exercise conditions and health conditions. However, extended application of wearable devices is rather limited.

### SUMMARY

According to a first aspect of embodiments of the present disclosure, there is provided a document processing method. In the method, acquiring an electronic document; identifying a wearable device identification corresponding to the electronic document; and sending the electronic document and the corresponding wearable device identification to a server, so that the server stores the electronic document in a user account corresponding to the corresponding wearable device identification.

According to a second aspect of embodiments of the disclosure, there is provided a document processing method, comprising: receiving an electronic document and a wearable device identification corresponding to the electronic document; storing the electronic document in a user account corresponding to the corresponding wearable device identification.

According to a third aspect of embodiments of the disclosure, there is provided a document processing apparatus, comprising: a first acquiring module configured to acquire an electronic document; an identifying module configured to identify a wearable device identification corresponding to the electronic document; and a first sending module configured to send the electronic document and the corresponding wearable device identification to a server, so that the server stores the electronic document in a user account corresponding to the corresponding wearable device identification.

According to a fourth aspect of embodiments of the disclosure, there is provided a document processing apparatus, comprising: a first receiving module configured to receive an electronic document and a wearable device identification corresponding to the electronic document; a storing module configured to store the electronic document in a user account corresponding to the corresponding wearable device identification.

According to a fifth aspect of embodiments of the disclosure, there is provided a terminal device, comprising: a processor; and a memory configured to store instructions executable by the processor. The processor is configured to: acquire an electronic document; identify a wearable device identification corresponding to the electronic document; and send the electronic document and the corresponding wearable device identification to a server, so that the server stores the electronic document in a user account corresponding to the corresponding wearable device identification.

According to a sixth aspect of embodiments of the disclosure, there is provided a server, comprising: a processor; and a memory configured to store instructions executable by the processor. The processor is configured to: receive an electronic document and a wearable device identification corresponding to the electronic document; store the electronic document in a user account corresponding to the corresponding wearable device identification.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a first document processing method according to an exemplary embodiment;

FIG. 2 is a flow chart showing a second document processing method according to an exemplary embodiment;

FIG. 3 is a flow chart showing a third document processing method according to an exemplary embodiment;

FIG. 4 is a flow chart showing a fourth document processing method according to an exemplary embodiment;

FIG. 5 is a flow chart showing a fifth document processing method according to an exemplary embodiment;

FIG. 6 is a block diagram showing a first document processing apparatus according to an exemplary embodiment;

FIG. 7 is a block diagram showing a second document processing apparatus according to an exemplary embodiment;

FIG. 8 is a block diagram showing a third document processing apparatus according to an exemplary embodiment;

FIG. 9 is a block diagram showing another first document processing apparatus according to an exemplary embodiment;

FIG. 10 is a block diagram showing another second document processing apparatus according to an exemplary embodiment;

FIG. 11 is a block diagram showing a terminal device according to an exemplary embodiment;

FIG. 12 is a block diagram showing another terminal device according to an exemplary embodiment;

FIG. 13 is a block diagram showing a server according to an exemplary embodiment;

FIG. 14 is a block diagram showing another server according to an exemplary embodiment.

The above drawings illustrate specific embodiments of the disclosure which will be described in detail hereinafter. These drawings and description are not intended to limit the scope of the inventive concept in any way but to explain the concept of the disclosure to those skilled in the art by referring to the specific embodiments.

### DETAILED DESCRIPTION

Reference will now be made in detail to certain embodiments, examples of which are illustrated in the accompanying drawings. The following description refers to the accompanying drawings in which the same numbers in different figures represent the same or similar elements unless otherwise indicated. The implementations set forth in the following description of embodiments do not represent all implementations consistent with the disclosure. Instead, they are merely examples of devices and methods consistent with aspects related to the disclosure as recited in the appended claims.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

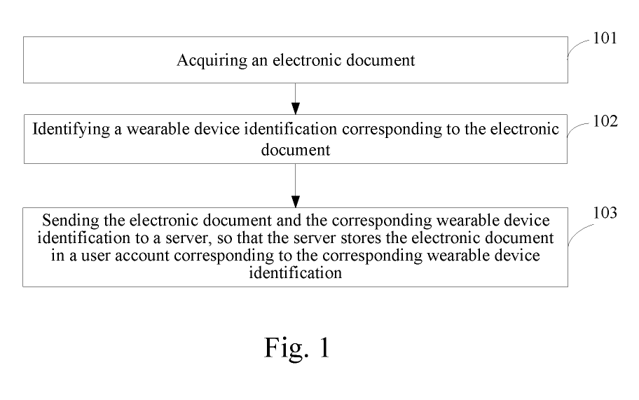

FIG. 1 is a flow chart showing a first document processing method according to an exemplary embodiment. The method may be implemented by a document processing apparatus, which may be an APP or a terminal device. As shown in FIG. 1, the method includes the following steps. The terminal device may be a cashier terminal, a user terminal, a ticket terminal, a smart phone, etc.

In step 101, an electronic document is acquired. The document may include a bill, an invoice, a receipt, a ticket, etc. For example, a cashier terminal may acquire the electronic bill for a user by scanning the products in the shopping cart. The electronic document may be a text format or an image format. A movie theater may use a ticket terminal to issue an electronic ticket to a user and/or acquire an electronic ticket from a smart bracelet of a user.

In step 102, a wearable device identification corresponding to the electronic document is identified. The cashier terminal may obtain the wearable device identification of the user by scanning the wearable device or communicating with the wearable device.

In step 103, the electronic document and the corresponding wearable device identification are sent to a server, so that the server stores the electronic document in a user account corresponding to the corresponding wearable device identification. For example, the cashier terminal may send the electronic document and the corresponding wearable device identification to the server over a secured network connection.

Taking an example where a user goes to a supermarket for shopping, when the user checks out after shopping, a cashier terminal in the supermarket generates a corresponding electronic document by scanning codes on goods and prompts the user to perform payment according to the amount on the electronic document, as is the conventional checkout process.

After the user completes the payment, the method according to one or more embodiments is triggered to manage the electronic document.

For example, if the user wears a wearable device such as a smart bracelet, a smart watch, etc., storage of the user's electronic document can be realized by virtue of the wearable device. The user may open the corresponding mobile APP for the wearable device and click on a menu in the mobile APP to manage the electronic document. Alternatively or additionally, the user may tap the wearable device itself according to a preset gesture to activate the management of the electronic document. Alternatively or additionally, the cashier terminal may recognize the wearable device automatically.

Generally, when the wearable device is used for the first time, the user may have to go through a registration process to register the wearable device in a server. During the registration, the user creates a user account. Meanwhile, the server prompts the user to input an identification of his/her wearable device, so as to store the user account in association with the wearable device identification, namely, store the user account and the wearable device identification in a binding manner. After the initial registration, the user may need to activate the electronic document for a specific store when he/she visit the store for the first time so that all future electronic documents for the store would be store in the same directory or marked with the same store name.

The wearable device identification may be an MAC address of the wearable device for uniquely identifying the wearable device. Moreover, a plurality of different wearable device identifications may be associated with the same user account.

In practical document processing, when the user completes the payment in the store, an identifying apparatus may be arranged at the checkout counter. The identifying apparatus may be integrated into the cashier terminal. After the user's electronic document is acquired, the identification of the user's wearable device is identified in one of various possible manners, which will be described by way of example in the following embodiments.

After the identification of the user's wearable device is identified, the wearable device identification and the electronic document are sent together to the server corresponding to the wearable device. According to a correspondence between the registered wearable device identification and the user account, the server determines the user account corresponding to the identified wearable device identification, so as to electronically store the electronic document under the user account. The electronic document may include the store information such as the store name and location so that the electronic document may be categorized according to the store information.

In practical implementation, after the electronic document is stored under the user account, the user may access the server using an APP in his/her terminal device (such as smart phone) which corresponds to the wearable device, to query about his/her consumptions during a period of time for collecting information on his/her consumptions. The user may also run reports on the APP for the spending in a particular location or a particular store. For example, the server may acquire an order summary based on the electronic document and update a spending summary corresponding to the user account based on the order summary, where the spending summary may be a weekly spending summary, a monthly spending summary, etc.

In this embodiment, when a user needs to perform payment, an electronic document for the payment is generated. After the user completes the payment, the electronic document is acquired and a wearable device identification is identified, so that the electronic document and the wearable device identification corresponding to the electronic document are sent to a server. The server stores the electronic document in a user account corresponding to the wearable device identification, for storing and managing the electronic document. By storing the electronic document in the user account, there is no need for a paper document and paper resources are saved. Meanwhile, storing the electronic document in association with the user account corresponding to the wearable device identification allows the wearable device to function as an identification device, which extends the application of the wearable device and improves user experience.

Alternatively or additionally, the server may calculate a credit score corresponding to the user account based on the spending summary. The server may then send the credit score to a terminal device so that the terminal device may display the credit score on the terminal device. The server may use at least one of the credit score and the location information of the electronic document to select one or more mobile advertisement or other promotional messages to deliver to the terminal device. Thus, the terminal device may display the one or more mobile advertisements on the terminal device if the user agrees to allow such promotional messages to be delivered.

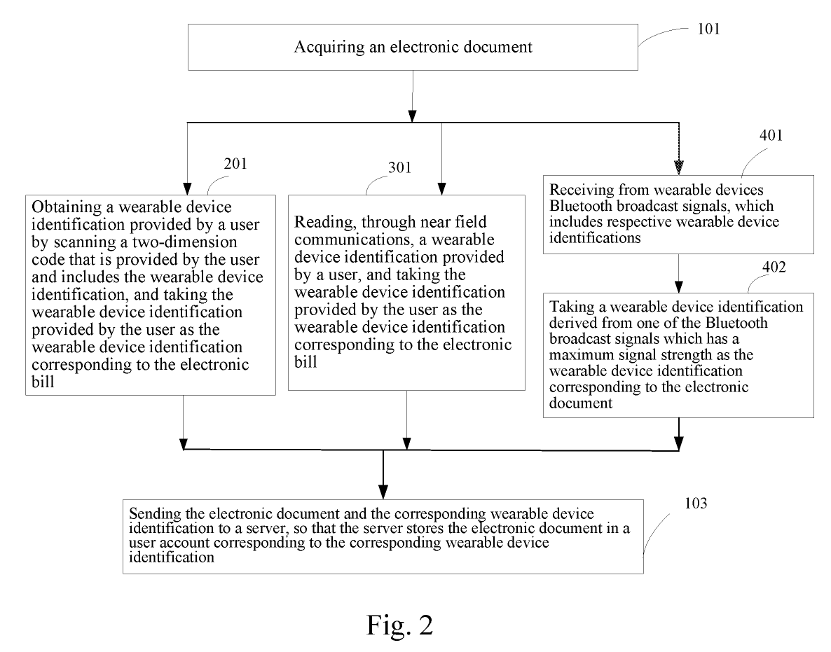

FIG. 2 is a flow chart showing a second document processing method according to an exemplary embodiment. As shown in FIG. 2, the above step 102 may be implemented in the following optional manners.

According to a first manner, in step 201, a cashier terminal obtains a wearable device identification by scanning a two-dimensional code. The two-dimensional code may be displayed in a smart phone paired with the wearable device. Alternatively or additionally, the two-dimensional code may be displayed in a screen of the wearable device. The two-dimensional code includes the wearable device identification, which is taken as the corresponding wearable device identification by the cashier terminal.

Further, the two-dimension code including the wearable device identification may be arranged on the external surface of the wearable device or displayed in response to the user's triggering operation. As such, the cashier terminal can acquire the wearable device identification corresponding to the electronic document by scanning using a scanner.

According to a second manner, in step 301, the cashier terminal may obtain a wearable device identification by communicating with the wearable device through near field communications, where the wearable device identification provided by the wearable device is taken as the wearable device identification corresponding to the electronic document.

In this implementation manner, an NFC reading apparatus may be arranged in the cashier terminal. Accordingly, a corresponding NFC communication module is provided in the wearable device. Through communications between the wearable device and the reading apparatus, the reading apparatus can read the wearable device identification and take it as the wearable device identification corresponding to the acquired electronic document.

According to a third manner, in step 401, the cashier terminal may receive Bluetooth broadcast signals from wearable devices, where the Bluetooth broadcast signals include respective wearable device identifications.

In step 402, the cashier terminal selects the Bluetooth broadcast signal that has a maximum signal strength. The cashier terminal then derives a wearable device identification derived from the selected Bluetooth broadcast signal and take the derived wearable device identification as the wearable device identification corresponding to the electronic document. The signal strength may be measured by the peak power value, the averaged power value, or other metrics of the Bluetooth signal received by the cashier terminal. Other types of location-based service may be provided to the terminal device based on the information in the electronic document as well.

In this implementation manner, a Bluetooth apparatus may be arranged in the cashier terminal. Accordingly, a Bluetooth communication module is provided in the wearable device. As compared with the first and the second implementation manners which ensure certainty of one-to-one identifying (that is, even though there are many other users wearing wearable devices near the user corresponding to the electronic document, only a single wearable device identification can be identified as corresponding to one electronic document due to the inherent nature of the above two implementation manners), the Bluetooth manner suffers from uncertainty, namely, multiple wearable device identifications may be identified as corresponding to one electronic document.

Therefore, when there are other persons wearing wearable devices having their Bluetooth functions enabled near the user corresponding to the electronic document, the wearable devices will send out broadcast signals, that is, the above-mentioned Bluetooth broadcast signals, respectively. The broadcast signals contain identifications of the respective wearable devices.

To avoid errors in identifying the wearable device through Bluetooth, the wearable device identification corresponding to the electronic document is identified based on the signal strengths of the received broadcast signals.

In an actual application scenario (for example, in a supermarket), when queuing for checkout, a user who is checking out will stand more closer to a checkout counter than other users; or when a cashier prompts the user that he/she can store his/her electronic document in a server by virtue of his/her wearable device, the user will deliberately move his/her wearable device close to the Bluetooth apparatus arranged at the checkout counter including the cashier terminal. In case the surrounding environment is the same, the received signal strength of the Bluetooth broadcast signal from the user's wearable device may be higher than those of the Bluetooth broadcast signals from others' wearable devices.

As such, the wearable device identification derived from one of the broadcast signals which has a maximum signal strength can be taken as the wearable device identification corresponding to the electronic document.

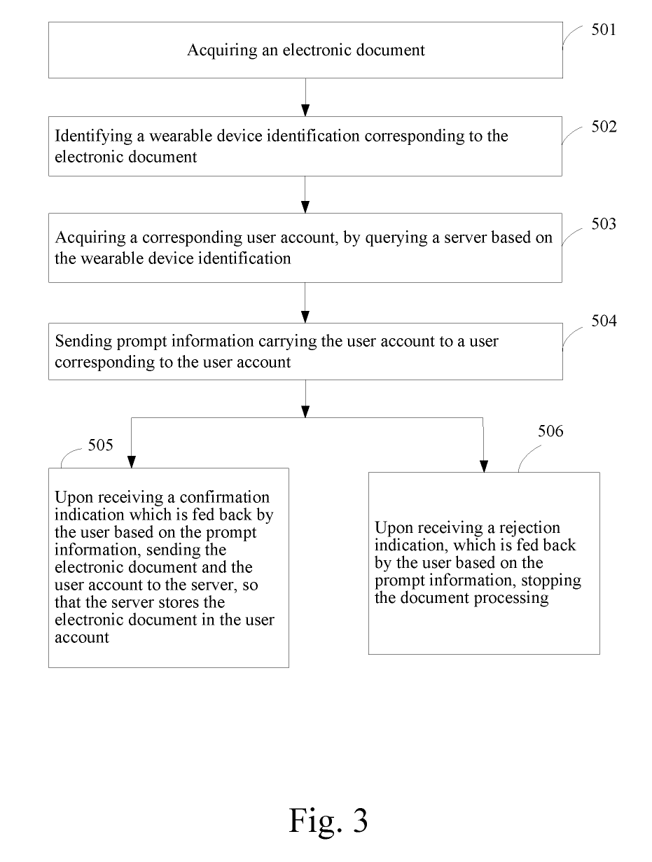

FIG. 3 is a flow chart showing a third document processing method according to an exemplary embodiment. As shown in FIG. 3, the method may include the following steps.

In step 501, an electronic document is acquired. The electronic document may be acquired by a cashier terminal as discussed above.

In step 502, a wearable device identification corresponding to the electronic document is identified. The wearable device identification may be identified by the cashier terminal.

The above two steps are consistent with corresponding steps in the embodiment shown in FIG. 1 and will be not described redundantly.

In step 503, a corresponding user account is acquired by querying a server based on the wearable device identification. For example, the cashier terminal may acquire the corresponding user account by querying the server using the wearable device identification.

In step 504, prompt information carrying the user account is sent to a user terminal corresponding to the user account. The server may send the prompt information to the user terminal such as a smart phone.

In step 505, when a confirmation indication which is fed back by the user based on the prompt information is received, the electronic document and the user account are sent to the server, so that the server stores the electronic document in the user account. For example, when the cashier terminal receives the confirmation indication from the user terminal, the cashier terminal may send the electronic document and the user account to the server so that the server stores the information in a particular directory under the user account.

In step 506, when the cashier terminal or the server receives a rejection indication from the user terminal, the cashier terminal or the server will stop processing the electronic document. Here, the rejection indication may be fed back by the user terminal based on the prompt information.

It can be appreciated that the order of the above steps 505 and 506 is not restricted.

In this embodiment, to further improve user experience and further ensure accurate storage of the electronic document, interaction with the user is performed.

For example, after a wearable device identification is identified, the server is queried based on the wearable device identification to obtain a corresponding user account, such as a user name. As such, by displaying prompt information on the display screen, the user name is displayed to the user, so as to prompt the user to confirm whether it is his/her user account. The display screen may be part of the wearable device or a part of the user terminal.

If the user confirms that it is his/her user account and that he/she agrees to store the electronic document in the server, the electronic document and the user account can be sent to the server based on the user's confirmation indication, so that the server stores the electronic document in the user account.

Otherwise, if the user confirms that it is not his/her user account or that the electronic document does not need to be stored in the server, the document processing can be stopped based on the user's rejection indication. That is, the electronic document will not be stored in the user account.

In this embodiment, by performing interaction with the user, the user can himself/herself decide whether to store the electronic document, thereby improving user experience while ensuring accurate storage of the electronic document.

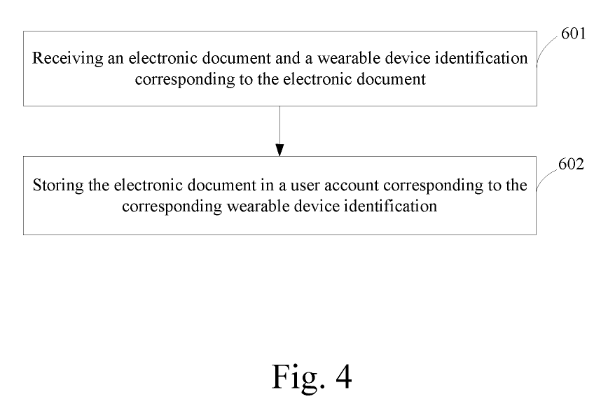

FIG. 4 is a flowchart showing a fourth document processing method according to an exemplary embodiment. The method is performed by a server. As shown in FIG. 4, the method includes the following steps.

In step 601, an electronic document and a wearable device identification corresponding to the electronic document are received.

In step 602, the electronic document is stored in a user account corresponding to the corresponding wearable device identification.

For example, in case the user wears a wearable device such as a smart bracelet, a smart watch etc., storage of the user's electronic document can be realized by using the wearable device as an access token.

After the user completes the payment, the method according to this embodiment is triggered to manage the electronic document. For example, when the user completes the payment, an identifying apparatus may be arranged in the cashier terminal at the checkout counter. After the user's electronic document is acquired, the identification of the user's wearable device is identified, so that the electronic document and the wearable device identification corresponding to the electronic document are sent to the server by the cashier terminal.

Because a user's user account is registered in the server when the user uses his/her wearable device for the first time, the server stores a correspondence between the registered user account and the identification of the wearable device. Therefore, after the server receives the electronic document and the wearable device identification corresponding to the electronic document, the server may determine the corresponding user account based on the wearable device identification, so as to store the electronic document under the user account, namely, in storage space corresponding to the user account and/or store information in the electronic document.

For the process of acquiring the wearable device identification corresponding to the electronic document, reference can be made to those implementation manners in the embodiment shown in FIG. 2 and description thereof will not be given redundantly.

In this embodiment, storage and management of the electronic document in the server are realized by allow the wearable device to function as an access token, making it convenient for the user to collect information on his/her consumptions and to get knowledge of his/her consumptions in time, thereby improving user experience.

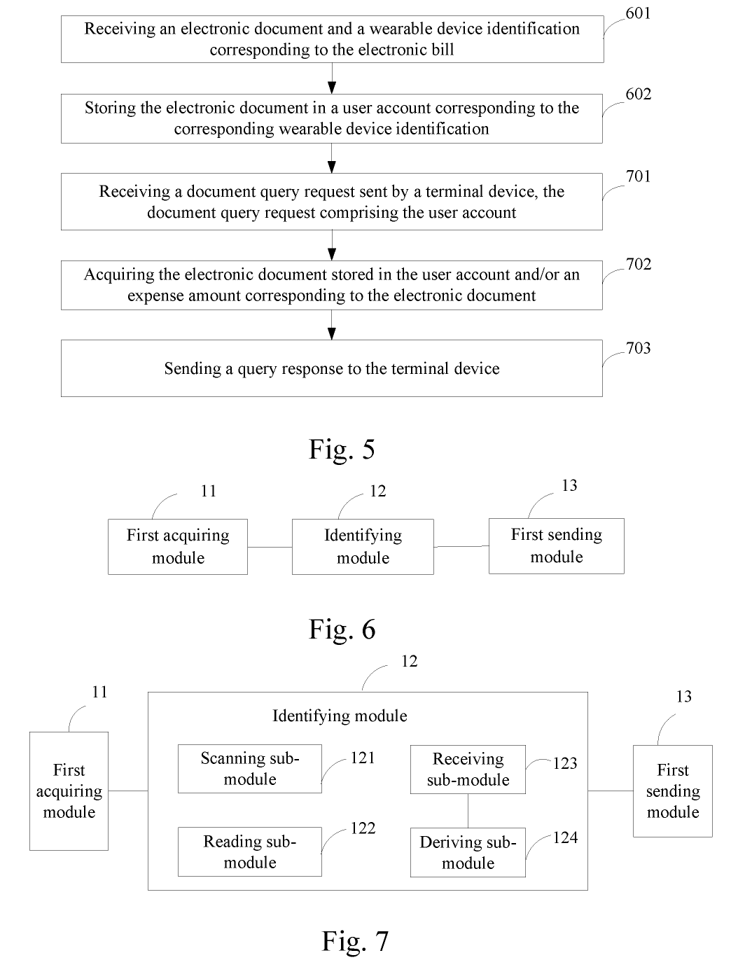

FIG. 5 is a flow chart showing a fifth document processing method according to an exemplary embodiment. As shown in FIG. 5, after the above step 602, the method may further include the following steps.

In step 701, a document query request sent by a terminal device is received, the document query request including the user account.

In step 702, the electronic document stored in the user account and/or an expense amount corresponding to the electronic document are acquired.

In step 703, a query response is sent to the terminal device.

In this embodiment, the user can perform querying based on the electronic document stored in the server, to get knowledge of his/her consumptions during a period of time conveniently.

For example, the user may send a query request to the server using a terminal device such as a mobile phone. The query request includes the user's user account. It can be appreciated that the query request further comprises among others a time and an indication message. The time indicates a time period, so that information on electronic document consumptions during this period is acquired. The indication message indicates that the query request is used to request querying about the electronic document.

As such, the server acquires the corresponding electronic document based on the query request, and can feed the electronic document and/or an expense amount corresponding to the electronic document back to the user's terminal device.

FIG. 6 is a block diagram showing a first document processing apparatus according to an exemplary embodiment. As shown in FIG. 6, the apparatus includes a first acquiring module 11, an identifying module 12 and a first sending module 13. Here, the modules may be implemented using one or more circuitries, integrated circuit chips, etc.

The first acquiring module 11 is configured to acquire an electronic document.

The identifying module 12 is configured to identify a wearable device identification corresponding to the electronic document.

The first sending module 13 is configured to send the electronic document and the corresponding wearable device identification to a server, so that the server stores the electronic document in a user account corresponding to the corresponding wearable device identification.

The document processing apparatus provided by this embodiment may be used to perform the technical solution of the method embodiment shown in FIG. 1.

In this embodiment, when a user needs to make a payment and completes the payment, the first acquiring module 11 acquires the paid electronic document and the identifying module 12 identifies a wearable device identification, so that the electronic document and the wearable device identification corresponding to the electronic document are sent by the first sending module 13 to a server. The server stores the electronic document in a user account corresponding to the wearable device identification, for storing and managing the electronic document. By storing the electronic document in the user account, there is no need for a paper document and paper resources are saved. Meanwhile, storing the electronic document in association with the user account corresponding to the wearable device identification allows the wearable device to function as an identification device, which extends the application of the wearable device and improves user experience.

FIG. 7 is a block diagram showing a second document processing apparatus according to an exemplary embodiment. As shown in FIG. 7, further to the embodiment shown in FIG. 6, the identifying module 12 includes a scanning sub-module 121 or a reading sub-module 122. Alternatively or additionally, the identifying module 12 includes a receiving sub-module 123 and a deriving sub-module 124.

The scanning sub-module 121 is configured to obtain a wearable device identification provided by a user by scanning a two-dimension code which is provided by the user and which includes the wearable device identification. The scanning sub-module 121 takes the wearable device identification provided by the user as the corresponding wearable device identification.

The reading sub-module 122 is configured to read, through near field communications, a wearable device identification provided by a user and to take the wearable device identification provided by the user as the corresponding wearable device identification.

The receiving sub-module 123 is configured to receive from wearable devices Bluetooth broadcast signals, which include respective wearable device identifications.

The deriving sub-module 124 is configured to take a wearable device identification derived from one of the Bluetooth broadcast signals which has a maximum signal strength as the corresponding wearable device identification.

The document processing apparatus provided by this embodiment may be used to perform the technical solution of the method embodiment shown in FIG. 2.

Optionally, the two-dimensional code including the wearable device identification may be arranged on the external surface of the wearable device or displayed in response to the user's triggering operation. As such, the cashier terminal can acquire the wearable device identification corresponding to the electronic document by scanning using a scanning sub-module 121.

Optionally, a NFC communication module is provided in the wearable device. Through communications between the wearable device and the reading apparatus 122, the reading sub-module 122 can read the wearable device identification corresponding to the electronic document.

Optionally, a Bluetooth communication module is provided in the wearable device to send out a Bluetooth broadcast signal carrying the wearable device identification. By receiving Bluetooth broadcast signals sent out by respective wearable devices having Bluetooth communication modules, the receiving sub-module 123 enables the deriving sub-module 124 to derive the wearable device identification corresponding to the electronic document from one of the Bluetooth broadcast signals which has a maximum signal strength.

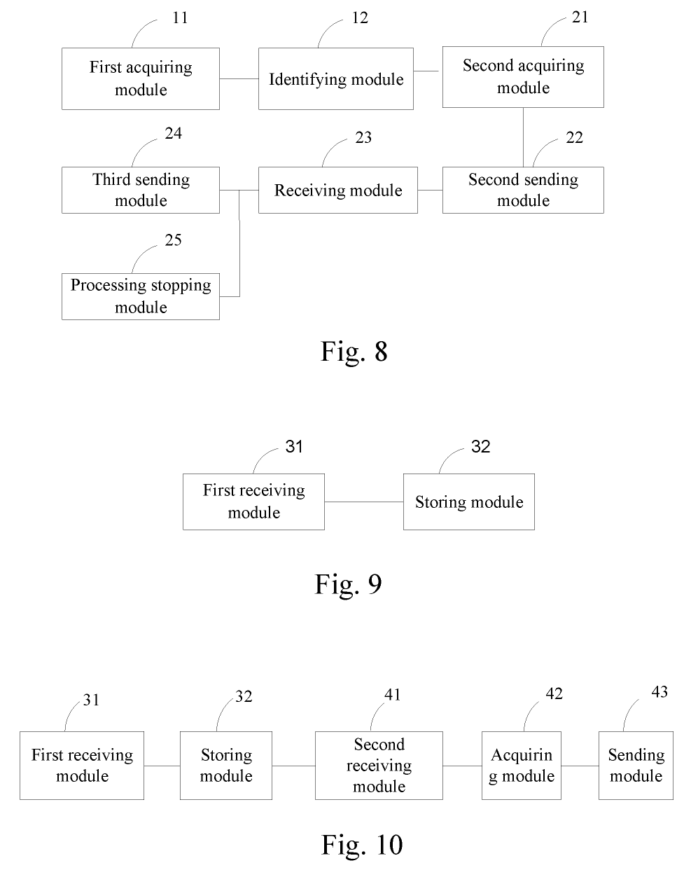

FIG. 8 is a block diagram showing a third document processing apparatus according to an exemplary embodiment. As shown in FIG. 8, further to the above embodiment, the apparatus includes a second acquiring module 21, a second sending module 22, a receiving module 23, a third sending module 24, and a processing stopping module 25.

The second acquiring module 21 is configured to acquire the user account by querying the server based on the corresponding wearable device identification.

The second sending module 22 is configured to send prompt information carrying the user account to the user corresponding to the user account.

The receiving module 23 is configured to receive an indication which is fed back by the user based on the prompt information.

The third sending module 24 is configured to send the electronic document and the user account to the server so that the server stores the electronic document in the user account, when the receiving module 23 receives a confirmation indication which is fed back by the user based on the prompt information.

The processing stopping module 25 is configured to stop the document processing, when the receiving module 23 receives a rejection indication which is fed back by the user based on the prompt information.

The document processing apparatus provided by this embodiment may be used to implement the technical solution of the method embodiment shown in FIG. 3.

After the identifying module 12 identifies a wearable device identification, the second acquiring module 21 can query the server based on the wearable device identification to obtain a corresponding user account, such as a user name. As such, by displaying prompt information on the display screen, the second sending module 22 can display the user name to the user, so as to prompt the user to confirm whether it is his/her user account.

When the user confirms that it is his/her user account and that the electronic document needs to be stored in the server, the third sending module 24 can send the electronic document and the user account to the server based on the user's confirmation indication, so that the server stores the electronic document in the user account.

Otherwise, if the user confirms that it is not his/her user account or that the electronic document does not need to be stored in the server, the receiving module 23 will receive the user's rejection indication and the processing stopping module 25 can stop the document processing based on the user's rejection indication. That is, the electronic document will not be stored in the user account.

In this embodiment, by performing interaction with the user, the user can himself/herself decide whether to store the electronic document, thereby improving user experience while ensuring accurate storage of the electronic document.

FIG. 9 is a block diagram showing another first document processing apparatus according to an exemplary embodiment. As shown in FIG. 9, the document processing apparatus includes a first receiving module 31 and a storing module 32.

The first receiving module 31 is configured to receive an electronic document and a wearable device identification corresponding to the electronic document.

The storing module 32 is configured to store the electronic document in a user account corresponding to the corresponding wearable device identification.

For example, in case the user wears a wearable device such as a smart bracelet, a smart watch etc., storage of the user's electronic document can be realized by virtue of the wearable device.

After the user completes the payment, the method according to this embodiment is triggered to manage the electronic document. For example, when the user completes the payment, an identifying apparatus may be arranged at the cashier terminal in the checkout counter. After the user's electronic document is acquired, the identification of the user's wearable device is identified, so that the electronic document and the wearable device identification corresponding to the electronic document are sent to the server. The first receiving module 31 in the server receives the electronic document and the wearable device identification corresponding to the electronic document.

Because a user's user account is registered in the server when the user uses his/her wearable device for the first time, the server stores a correspondence between the registered user account and the identification of the wearable device. Therefore, after the first receiving module 31 receives the electronic document and the wearable device identification corresponding to the electronic document, the storing module 32 can determine the corresponding user account based on the wearable device identification, so as to store the electronic document under the user account, namely, in storage space corresponding to the user account.

For the process of acquiring the wearable device identification corresponding to the electronic document, reference can be made to those implementation manners in the embodiment shown in FIG. 2 and description thereof will not be given redundantly.

In this embodiment, storage and management of the electronic document in the server are realized by allowing the wearable device to function as an identification device, making it convenient for the user to collect information on his/her consumptions and to get informed of his/her consumptions in time, thereby improving user experience.

FIG. 10 is a block diagram showing another second document processing apparatus according to an exemplary embodiment. As shown in FIG. 10, further to the embodiment shown in FIG. 9, the document processing apparatus comprises a second receiving module 41, an acquiring module 42 and a sending module 43.

The second receiving module 41 is configured to receive a document query request sent by a terminal device, the document query request comprising the user account.

The acquiring module 42 is configured to acquire the electronic document stored in the user account and/or an expense amount corresponding to the electronic document.

The sending module 43 is configured to send a query response to the terminal device.

In this embodiment, the user can perform querying based on the electronic document stored in the server, to get knowledge of his/her consumptions during a period of time conveniently.

For example, the user can send a query request to the server using a terminal device such as a mobile phone. The query request includes the user's user account. It can be appreciated that the query request further includes among others a time and an indication message. The time indicates a time period, so that information on electronic document consumptions during this period is acquired. The indication message indicates that the query request is used to request querying about the electronic document.

As such, after the second receiving module 41 receives the query request, the acquiring module 42 acquires the corresponding electronic document and an expense amount corresponding to the electronic document from the user account. Then, the electronic document or the expense amount corresponding to the electronic document can be fed back by the sending module 43 to the user's terminal device.

Detailed operations performed by modules and sub-modules of the document processing apparatus in the above embodiments have been described in the embodiments of related method embodiments, and will not be described here in detail any more.

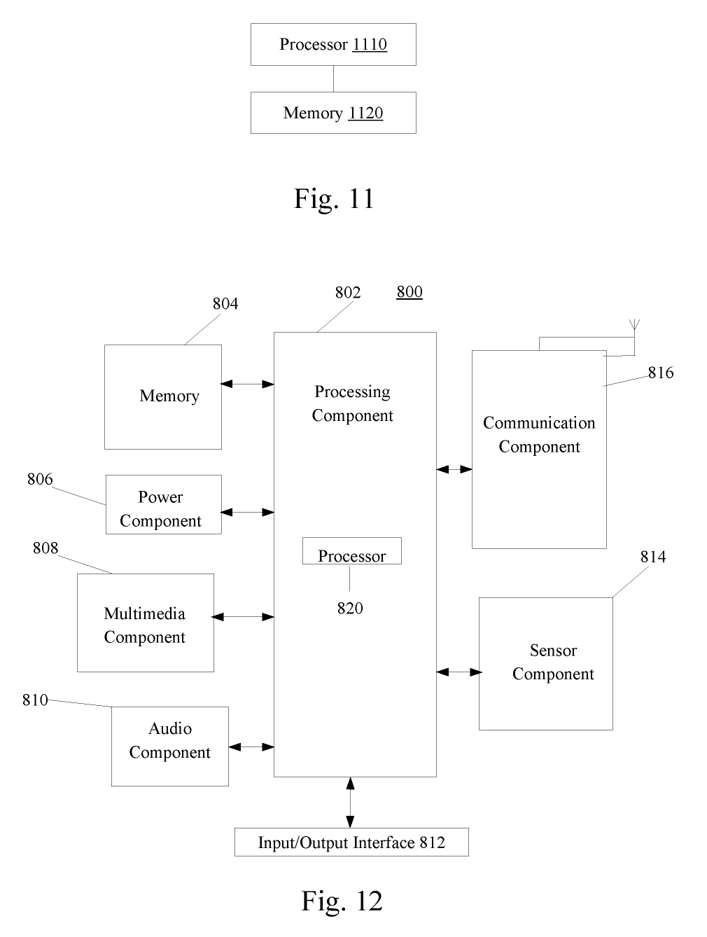

In the foregoing, internal functions and structures of the document processing apparatus are described. As shown in FIG. 11, in practice, the document processing apparatus may be implemented as a terminal device, which includes a processor 1110 and a memory 1120 for storing instructions executable by the processor. The processor 1110 is configured to: acquire an electronic document; identify a wearable device identification corresponding to the electronic document; and send the electronic document and the corresponding wearable device identification to a server, so that the server stores the electronic document in a user account corresponding to the corresponding wearable device identification.

In this embodiment, when a user needs to perform payment, an electronic document for the payment is generated. After the user completes the payment, the electronic document is acquired and a wearable device identification is identified, so that the electronic document and the wearable device identification are sent to a server. The server stores the electronic document in a user account corresponding to the wearable device identification, for storing and managing the electronic document. By storing the electronic document in the user account, there is no need for a paper document and paper resources are saved. Meanwhile, storing the electronic document in association with the user account corresponding to the wearable device identification allows the wearable device to function as an identification device, which extends the application of the wearable device and improves user experience.

FIG. 12 is a block diagram showing another terminal device according to an exemplary embodiment. For example, the terminal device 800 may be a mobile phone, a computer, a digital broadcast terminal, a messaging device, a gaming console, a tablet, a medical device, exercise equipment, a personal digital assistant or the like.

Referring to FIG. 12, the terminal device 800 may include one or more of the following components: a processing component 802, a memory 804, a power component 806, a multimedia component 808, an audio component 810, an input/output (I/O) interface 812, a sensor component 814 and a communication component 816.

The processing component 802 generally controls the overall operations of the terminal device 800, for example, display, phone call, data communication, camera operation and record operation. The processing component 802 may include one or more processors 820 to implement an instruction to complete all or part of the steps of the above methods. In addition, the processing component 802 may include one or more modules to facilitate the interaction between the processing component 802 and other components. For example, the processing component 802 may include a multimedia module to facilitate the interaction between the processing component 808 and the processing component 802.

The memory 804 is configured to store various types of data to support the operation performed on the device 800. The examples of such data include an instruction of any application program or method, contact data, address book data, massages, pictures, videos, etc. which are operated on the device 800. The memory 804 may be realized with any kind of a volatile and non-volatile storage device or combination thereof, for example, Static Random Access Memory (SRAM), Electrically-Erasable Programmable Read Only Memory (EEPROM), Erasable Programmable Read Only Memory (EPROM), Programmable Read Only Memory (PROM), Read Only Memory (ROM), a magnetic memory, a flash memory, a magnetic disk or an optical disk.

The power component 806 provides power for various components of the terminal device 800. The power component 806 may include a power supply management system, one or more power supplies, and other components for generating, managing and distributing power to the terminal device 800.

The multimedia component 808 includes a screen providing an output interface between the terminal device 800 and the user. In some embodiments, the screen may include a Liquid Crystal Display (LCD) and a Touch Panel (TP). If the screen includes the touch panel, the screen may be realized as a touch screen to receive an input information from the user. The touch panel includes one or more touch sensors to sense the touching, sliding and the gestures on the touch panel. The touch sensor may not only sense the touching or border of sliding gesture but only detect the duration time and pressure related to touching or sliding operation. In some embodiments, the multimedia component 808 includes one front-facing camera and/or one rear-facing camera. When the terminal device 800 is in an operation mode, for example, a shooting mode or a video mode, the front-facing camera and/or the rear-facing camera may receive outside multimedia data. Each one of front-facing camera and rear-facing camera may be one fixed optical lens system or have focal length or optical zoom ability.

The audio component 810 is configured to output and/or input audio information. For example, the audio component 810 includes one microphone (MIC). When the terminal device 800 is in the operation mode, for example, a calling mode, a record mode and a speech recognition mode, the microphone is configured to receive outside audio information. The received audio information may be further stored in the memory 804 or sent via the communication component 816. In some embodiments, the audio component 810 includes may include a speaker configured to output audio information.

The I/O interface 812 provides an interface between the processing component 802 and a peripheral interface module. The above peripheral interface module may be a keyboard, a click wheel, and button, etc. The button may include but not limit to home page button, volume button, start button and lock button.

The sensor component 814 includes one or more sensors and is configured to provide various aspects of the assessment state for the terminal device 800. For example, the sensor component 814 may detect the on/off state of the terminal device 800, the relative positioning of the components (for example, the components are display and a keypad of the terminal device 800), position change of the terminal device 800 or one component of the terminal device 800, presence or absence of the touch between the user and the terminal device 800, as well as the orientation or acceleration/deceleration and temperature change of the terminal device 800. The sensor component 814 may include a proximity sensor configured to detect the presence of an adjacent object when there is not any physical contact.

The sensor component 814 may also include an optical sensor (such as CMOS or a CCD image sensor) configured to be used in imaging application. The sensor component 814 may be configured to scan the two-dimensional code so that the processor 820 may obtain the wearable device identification from the scanned two-dimensional code. In some embodiments, the sensor component 814 may also include an acceleration sensor, a gyro sensor, a magnetic sensor, a pressure sensor or a temperature sensor.

The communication component 816 is configured to facilitate the wired or wireless communication between the terminal device 800 and other apparatuses. The terminal device 800 may access the wireless network based on a communication standard, such as WiFi, 2G or 3G or a combination thereof. In one exemplary embodiment, the communication component 816 receives a broadcast information or broadcast associated information from an external broadcast management system via a broadcast channel. In one exemplary embodiment, the communication component 816 also includes a Near Field Communication (NFC) module to facilitate short-range communication. For example, the NFC module may be based on Radio Frequency Identification (RFID) technology, Infrared Data Association (IrDA) technology, Ultra-Wideband (UWB) technology, Bluetooth (BT) technology and other technologies. The communication component 816 may communicate with a wearable device so that the processor may obtain the wearable device identification using through the communication.

In an exemplary embodiment, the terminal device 800 may be realized through one or more Application Specific Integrated Circuits (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic elements, and configured to carry out the aforementioned methods.

In an exemplary embodiment, a non-transitory computer-readable storage medium comprising the instruction is also provided, for example, the memory 804 including the instruction. The above instruction may be carried out by the processor 820 of the terminal device 800 to complete the above methods. For example, the non-transitory computer-readable storage medium may be a ROM, a random access memory (RAM), a CD-ROM, a magnetic tape, a floppy disk, an optical data storage devices and the like.

There is provided a non-transitory computer-readable storage medium having stored therein instructions that, when executed by a processor of a mobile terminal, cause the mobile terminal to perform a document processing method, the method comprising: acquiring an electronic document; identifying a wearable device identification corresponding to the electronic document; and sending the electronic document and the corresponding wearable device identification to a server, so that the server stores the electronic document in a user account corresponding to the corresponding wearable device identification

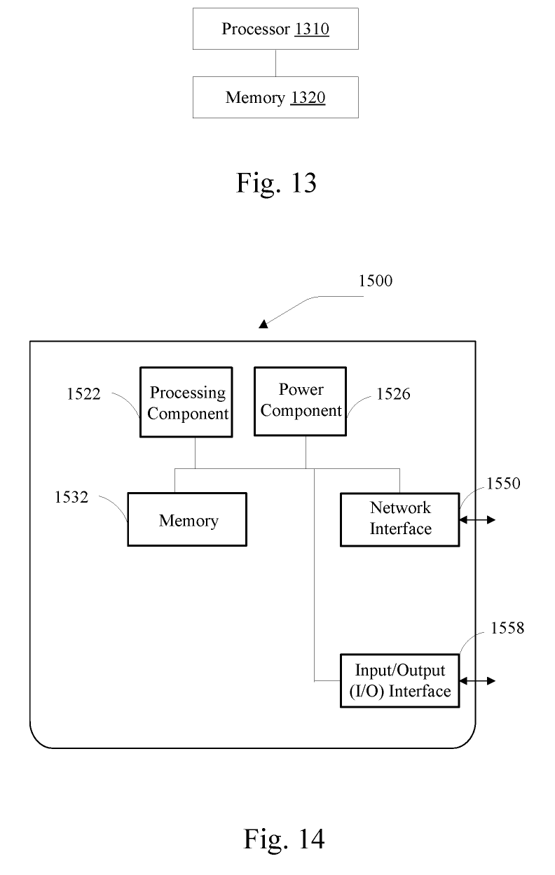

In addition, as shown in FIG. 13, in practice, the above-mentioned another document processing apparatus may implemented as a server, which includes a processor 1310 and a memory 1320 for storing instructions executable by the processor. The processor 1310 is configured to: receive an electronic document and a wearable device identification corresponding to the electronic document; store the electronic document in a user account corresponding to the corresponding wearable device identification.

FIG. 14 is a block diagram showing another server according to an exemplary embodiment. Referring to FIG. 14, the server 1500 includes a processing component 1522 which further includes one or more processors, and memory resources that a memory 1532 represents for storing instructions executable by the processing component 1522, e.g., applications. The application programs stored in the memory 1532 may include one or more modules each corresponding to a set of instructions. In addition, the processing component 1522 is configured to execute instructions, so as to implement the above method which includes: receiving an electronic document and a wearable device identification corresponding to the electronic document; storing the electronic document in a user account corresponding to the corresponding wearable device identification.

The server 1500 may further include a power component 1526 configured to perform power management for the apparatus 1500, a wired or wireless network interface 1550 configured to connect the server 1500 to a network, and an input/output (I/O) interface 1558. The server 1500 can be operated based on an operating system stored in the memory 1532, e.g., Windows Server™, Mac OS X™, Unix™, Linux™, FreeBSD™ or the like.

Those skilled in the art may easily conceive other embodiments of the disclosure from consideration of the specification and practice of the present disclosure. This application is intended to cover any variations, uses, or adaptations of the disclosure following the general principles thereof and including such departures from the present disclosure as come within known or customary practice in the art. The specification and examples are intended to be exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A document processing method, comprising:
acquiring, by a terminal device, an electronic document;
identifying, by the terminal device, a wearable device identification corresponding to the electronic document; and
sending, by the terminal device, the electronic document and the wearable device identification to a server, so that the server stores the electronic document in a user account corresponding to the wearable device identification.

2. The method according to claim 1, wherein identifying the wearable device identification corresponding to the electronic document comprises:
obtaining, by the terminal device, the wearable device identification by scanning a two-dimension code that comprises the wearable device identification; or
reading, by the terminal device, through near field communications, the wearable device identification from a wearable device.

3. The method according to claim 1, wherein identifying the wearable device identification corresponding to the electronic document comprises:
receiving, by the terminal device, Bluetooth broadcast signals from one or more wearable devices, wherein each Bluetooth broadcast signal comprises a device identification;
selecting the device identification from the Bluetooth broadcast signal having a maximum signal strength among all Bluetooth broadcast signals; and
taking the selected device identification as the wearable device identification

4. The method according to claim 1, further comprising:
acquiring the user account by querying the server based on the wearable device identification; and
sending prompt information carrying the user account to a user terminal corresponding to the user account.

5. The method according to claim 1, further comprising:
acquiring an order summary based on the electronic document; and
updating a spending summary corresponding to the user account based on the order summary.

6. The method according to claim 5, further comprising:
obtaining a credit score corresponding to the user account based on the spending summary; and
displaying the credit score on the terminal device.

7. The method according to claim 4, further comprising:
upon receiving a confirmation indication which is fed back by the user terminal based on the prompt information, sending the electronic document and the user account to the server, so that the server stores the electronic document in the user account; and
upon receiving a rejection indication, which is fed back by the user terminal based on the prompt information, stopping the document processing.

8. The method according to claim 5, further comprising:
upon receiving a confirmation indication which is fed back by the user based on the prompt information, sending the electronic document and the user account to the server, so that the server stores the electronic document in the user account; and
upon receiving a rejection indication, which is fed back by the user based on the prompt information, stopping the document processing.

9. The method according to claim 6, further comprising:
upon receiving a confirmation indication which is fed back by the user based on the prompt information, sending the electronic document and the user account to the server, so that the server stores the electronic document in the user account; and
upon receiving a rejection indication, which is fed back by the user based on the prompt information, stopping the document processing.

10. A document processing method, comprising:
receiving an electronic document and a wearable device identification corresponding to the electronic document; and
storing the electronic document in a user account corresponding to the wearable device identification.

11. The method according to claim 10, further comprising:
receiving a document query request sent by a terminal device, the document query request comprising the user account;
acquiring the electronic document stored in the user account and/or an expense amount corresponding to the electronic document; and
sending a query response to the terminal device.

12. A terminal device, comprising:
a processor;
a memory configured to store instructions executable by the processor,
wherein the processor is configured to
acquire an electronic document;
identify a wearable device identification corresponding to the electronic document; and
send the electronic document and the wearable device identification to a server, so that
the server stores the electronic document in a user account corresponding to the wearable device identification.

13. The apparatus of claim 12, wherein the processor is further configured to:
obtain the wearable device identification by scanning a two-dimension code that comprises the wearable device identification; or
read, through near field communications, the wearable device identification from a wearable device.

14. The apparatus of claim 12, wherein the processor is further configured to:
receive Bluetooth broadcast signals from one or more wearable devices, wherein each Bluetooth broadcast signal comprises a device identification;
select the device identification from the Bluetooth broadcast signal having a maximum signal strength among all Bluetooth broadcast signals; and
take the selected device identification as the wearable device identification.

15. The apparatus of claim 12, wherein the processor is further configured to:
acquire the user account by querying the server based on the wearable device identification; and
send prompt information carrying the user account to a user terminal corresponding to the user account.

16. The apparatus of claim 12, wherein the processor is further configured to:
acquire an order summary including location information based on the electronic document; and
update a spending summary corresponding to the user account based on the order summary.

17. The apparatus of claim 16, wherein the processor is further configured to:
obtain a credit score corresponding to the user account based on the spending summary;
obtain one or more mobile advertisements based on at least one of the credit score and the location information, and
display the one or more mobile advertisements on the terminal device.

18. The apparatus of claim 15, wherein the processor is further configured to:
upon receiving a confirmation indication which is fed back by the user terminal based on the prompt information, send the electronic document and the user account to the server, so that the server stores the electronic document in the user account; and
upon receiving a rejection indication, which is fed back by the user terminal based on the prompt information, stop the document processing.

19. The apparatus of claim 16, wherein the processor is further configured to:
upon receiving a confirmation indication which is fed back by the user based on the prompt information, send the electronic document and the user account to the server, so that the server stores the electronic document in the user account; and
upon receiving a rejection indication, which is fed back by the user based on the prompt information, stop the document processing.

20. The apparatus of claim 17, wherein the processor is further configured to:
upon receiving a confirmation indication which is fed back by the user based on the prompt information, send the electronic document and the user account to the server, so that the server stores the electronic document in the user account; and
upon receiving a rejection indication, which is fed back by the user based on the prompt information, stop the document processing.
